(19) United States
(12) Patent Application Publication
(10) Pub. No.: US 2012/0034287 A1
(43) Pub. Date: Feb. 9, 2012

(54) Quaternary Ammonium Glycol Ether Disinfectant Wipes

(76) Inventors: Lisa A. Napolitano, River Edge, NJ (US); Michael V. Monticello, Paramus, NJ (US); Roy Blank, Spring Valley, NY (US); Gabriel Odame, Bronx, NY (US)

(21) Appl. No.: 12/849,577

(22) Filed: Aug. 3, 2010

(51) Int. Cl. A01N 25/08; B05D 3/00; A01P 1/00; A01N 33/12

(52) U.S. Cl. 424/409; 514/642; 427/2.31

(57) ABSTRACT

A nonwoven absorbent wipe is impregnated with an antibacterial and antimicrobial composition comprising quaternary ammonium salts, glycol ethers, a surfactant and water. A method of preparation and a process for disinfecting hard surfaces with the wipe are provided.

### FIELD OF THE INVENTION

The present invention relates to disinfectant wipe products and compositions. More specifically, the invention relates to wipes pre-impregnated with an antibacterial and antimicrobial composition, compositions, methods of preparation, and processes for disinfecting hard surfaces with the wipes.

### BACKGROUND OF THE INVENTION

Quaternary ammonium salts are broad-spectrum antimicrobial and antibacterial commonly used in hard surface disinfectant products. They are typically available in commercial cleaning formulations with at least one surfactant and at least one organic solvent.

A particularly rigorous application of hard surface cleaning compositions is the class of hospital disinfectant products. Such products must be registered with the United States Environmental Protection Administration (EPA). Registration with the EPA requires submission of data establishing the disinfecting efficacy of the product. For example, DIS/TSS-1 Jan. 22, 1982 specifies the Efficacy Data Requirements for Disinfectants for Use on Hard Surfaces for hospital or medical environment claims. Label claims for use of disinfectants in hospital or medical environments are acceptable only for those products that are effective for general or broad-spectrum disinfection, particularly Staphylocooccus aureus and Salmonella enterica, and additionally against the nosocomial bacterial pathogen Pseudomonas aeruginosa. In general, the test requirements for hospital disinfectant label usage require meeting the standards of the AOAC Germicidal Spray Products Test (Method No. 961.02), e.g., sixty carriers must be tested against each of S. choleraesuis, S. aureus, and Pseudomonas aeruginosa ATCC 15442. For a product to be labeled as a disinfectant, it must kill 59 out of each set of 60 carriers, to provide effectiveness at the 95% confidence level. If the product is in the form of a towelette, the product will need to be tested in accordance with the test procedure specified in the American Society for Testing and Materials (ASTM) International's Standard Practice for Evaluation of Pre-saturated or Impregnated Towelettes for Hard Surface Disinfection (E2362-09), or the EPA's Standard Operation Procedure for Disinfecting Towelette Test against Staphyloccus aureus, Pseudomonas aeruginosa, and Salmonella enterica (SOP #MB-09-04, Revised Feb. 26, 2010).

In additional to germicidal efficacy, hospital disinfectant products should have low toxicity, no odor, non-flammability, low skin irritation and no staining upon contact with a surface, leave a minimum of discernible residue, clean well, and be competitively priced.

U.S. Pat. No. 5,444,094 to Stepan Company discloses a composition which comprises a quaternary ammonium salt, a glycol ether at a range of 8 w/w % to 80 w/w %, a strong alkali compound such as sodium metasilicate, and a chelating agent such as ethylenediaminetetraacetate (EDTA). While the composition is said to be able to kill tuberculosis-causing bacteria, it requires a medium to high level of the glycol ether and a strong alkali compound to enhance the germicidal effect of the quaternary ammonium salt.

Thus, there continues to be a need in the hospital disinfectant market for disinfectant quaternary ammonium salt products that provides immediate effective disinfecting properties after its application to a surface.

### SUMMARY OF THE INVENTION

It is an object of the invention to provide a disinfectant cleaning product which is particularly useful for cleaning and disinfecting hard surfaces.

It is a further object of the invention to provide a disinfecting product which may be registered with the EPA as a hospital disinfectant product.

In one aspect, the present invention is directed to antibacterial and antimicrobial wipe for disinfecting hard surfaces which comprises:
(a) an absorbent nonwoven substrate; and
(b) a liquid composition comprising, on a weight basis of the composition:
(i) a quaternary ammonium salt at a range of about 0.2 w/w % to about 2.0 w/w %, preferably about 0.2 w/w % to about 0.8 w/w %, and more preferably about 0.2 w/w % to about 0.5 w/w %;
(ii) a glycol ether at a range of about 0.5 w/w % to about 7.5 w/w %, preferably about 2.5 w/w % to about 6.0 w/w %, and more preferably about 4.0 w/w % or 5.0 w/w %;
(iii) a surfactant at a range of about 0.01 w/w % to about 0.5 w/w %, preferably about 0.05 w/w % to about 0.2 w/w %, and more preferably about 0.1 w/w %; and
(iv) the balance being water;

wherein the substrate is impregnated with the liquid composition at a loading level in the range from 1.5 xow to about 10 xow, preferably from about 2.5 xow to about 7.5 xow, and more preferably from about 3 xow to about 6 xow.

A preferred quaternary ammonium salt of the present invention is a mixture of n-alkyl (C₁₂-C₁₈) dimethyl benzyl ammonium chloride and n-alkyl (C₁₂-C₁₄) dimethyl ethylbenzyl ammonium chloride. A preferred glycol ether is dipropylene glycol mono-n-butyl ether or dipropylene glycol mono-n-propyl ether. A preferred surfactant is polyethylene glycol p-(1,1,3,3-tetramethylbutyl)phenyl ether.

It is believed that a synergistic effect has been discovered which arises from the specific combination of the quaternary ammonium salts, the glycol ether and the nonionic surfactant in the composition is applied using a wipe substrate in accordance with the present invention. The wipes and compositions use a lower level of each of the quaternary ammonium salts, the glycol ether, and surfactant to achieve disinfecting effects using a smaller quantity of glycol ether than required by prior art compositions. The specific combination of the nonionic surfactant and the glycol ether apparently works to activate the quaternary ammonium salts even at a low concentration to obtain enhanced effectiveness and the use of a wipe as an applicator gives a rapid antibacterial effect.

In another aspect, the present invention is directed to methods of preparation of the wipes. The methods start with mixing each component of the aforementioned composition until a homogenous solution or suspension is formed, followed by loading the resulting solution or suspension onto a nonwoven substrate. The methods may further include packaging the pre-impregnated wipes into individual or bulk containers.

In a further aspect, the present invention is directed to processes for disinfecting surfaces which comprise the step of applying the aforementioned disinfecting wipe to hard surfaces. The processes may optionally comprise the steps of scrubbing, rinsing, wiping the surfaces, and combinations thereof.

### DETAILED DESCRIPTION OF THE INVENTION

The disinfectant wipe, the methods of preparation, and the processes for disinfecting surfaces in accordance with the present invention will now be discussed in detail. It should be noted that the invention in its broader aspects is not limited to the specific details, representative compositions, methods, and processes, and illustrative examples described in connection with the preferred embodiments and preferred methods. Modifications and equivalents will be apparent to practitioners skilled in this art and are encompassed within the spirit and scope of the appended claims.

The Disinfectant Wipes:

Disinfectant applicators generally improve the performance of liquid disinfectants by providing mechanical cleaning properties to complement the liquid disinfectants. They also allow for a significant reduction in the level of non-volatile surfactants and other adjuvants needed to achieve desired disinfecting results. Among different applicators, wipes, especially disposable absorbent nonwoven wipes, provide versatility and convenience to users of the products.

The disinfectant wipes in accordance with the present invention comprise an absorbent nonwoven water-insoluble substrate impregnated with a disinfecting composition. The wipe substrate may be a sheet, pad, or multi-layer sponge product, and may be meant for use by itself or may be associated with an applicator handle or holder.

The nonwoven water-insoluble substrate for wipes may be made from plant-grown materials, or may be manufactured from processed plant-grown materials, or may be synthetic manmade materials. The nonwoven substrate can be made from the material such as viscose, rayon, polyester, wood pulp, polypropylene, polyethylene, nylon, or cotton.

Regardless of the material utilized to form the substrate, the basis weight of the substrate for the wipes is from about 10 grams per square meter (gsm) to about 200 gsm, preferably from about 20 gsm to about 100 gsm. The higher basis weight range is preferred due to higher loading capacity and heavier duty abilities in a hospital setting.

The substrate for the wipes in accordance with the present invention is loaded with the disinfecting composition at the loading level from about 1.5 times the original weight of the wipe (“xow”) to about 10 times the original weight of the wipe, preferably from about 2.5 xow to about 7.5 xow, and more preferably from about 3 xow to about 6 xow.

The wipes may come in a variety of shapes, including but not limited to, circular, oval, square, rectangular, or irregularly shaped.

Each individual wipe may be arranged in a folded configuration and stacked one on top of the other to provide a stack of wet wipes. The folded configurations are well known to those skilled in the art and include c-folded, z-folded, quarter-folded configurations and so forth. Alternatively, the wipes are configured as continuous wipes perforated in a stack or roll for dispensing. The wipes can consist of one or more layers including an optional scrub layer for maximum cleaning efficiency.

The Disinfectant Compositions:

The disinfecting compositions which are loaded onto the wipes comprise four components: a quaternary ammonium salt, a glycol ether, a surfactant, and water.

Quaternary ammonium salt (Quat) is used as a disinfecting agent due to its broad spectrum of antimicrobial and germicidal properties. The term “antimicrobial” used herein and in the appended claims refers to antibacterial, antifungal, antiviral and/or antinematode.

It is believed that quaternary ammonium salt acts by disrupting the cell membrane of organisms and bacteria and thus kills the organisms and bacteria. Suitable quaternary ammonium salts have the following general formula:

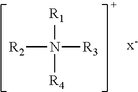

wherein R₁ and R₂ are straight or branched hydrocarbon chain having from one to seven carbon atoms; R₃ is a hydrocarbon chain having from eight to twenty carbon atoms, or a benzyl group; and R₄ is a hydrocarbon chain having from eight to twenty carbon atoms. The hydrocarbon chains of R₃ and R₄ can be branched or straight, and unsaturated or saturated

Preferably, R₁ and R₂ are selected from the group consisting methyl, ethyl, propyl, and mixtures thereof. More preferably, R₁ and R₂ are both methyl groups. Preferably, R₃ is a benzyl group, substituted or unsubstituted. More preferably, R₃ is an unsubstituted benzyl group. R₄ is a hydrocarbon chain preferably with ten to twenty carbon atoms, and more preferably, with twelve to eighteen carbon atoms.

The counterion X may be selected from, but not limited to, the group consisting of halogen, methylsulfate, cyclohexylsulphamate, saccharinate, carboxyl, and sulfonyl ions. Preferably, X is selected from the group consisting of chloride or bromide. More preferably, X is a chloride.

In preferred embodiments of the invention, the quaternary ammonium salt is alkyl dimethyl benzyl ammonium chloride (ADBAC), or alkyl dimethyl ethylbenzyl ammonium chloride (EBC), or a mixture thereof.

Other suitable quaternary ammonium compounds include dialkylmethyl amines quaternary salts (Dialkyl quats), and mixtures thereof, or mixtures with ADBAC or EBC quats. Other quaternary ammonium compounds such as are disclosed in U.S. Pat. No. 6,395,698, the disclosure of which is hereby incorporated by reference, may also be used.

In the most preferred embodiment, the quaternary ammonium compound is a mixture of n-alkyl (C₁₂-C₁₈) dimethyl benzyl ammonium chloride (ADBAC) and n-alkyl (C₁₂-C₁₄) dimethyl ethylbenzyl ammonium chloride (EBC), where the n-alkyl (C₁₂-C₁₈) is composed with 60% C₁₄, 30% C₁₆, 5% C₁₂, and 5% C₁₈, and the n-alkyl (C₁₂-C₁₄) is composed with 68% C₁₂ and 32% C₁₄, which is available from Stephan. Company under the trade name BTC 2125®M.

The quaternary ammonium salt in accordance with the invention can be present in an amount of about 0.2 w/w % to about 2.0 w/w %, preferably about 0.2 w/w % to about 0.8 w/w %, and more preferably about 0.2 w/w % to about 0.5 w/w % of the composition.

Glycol ether is employed as a co-solvent for the composition. Suitable glycol ethers are those having excellent solvent properties, efficient at reducing surface tension of liquids, and reasonably soluble in water. Ideally, the glycol ethers are biodegradable.

In accordance with the present invention, all glycol ethers may be employed as solvents for the composition. The preferred glycol ether for the composition is selected from the group consisting of dipropylene glycol mono-n-propyl ether (DPnP) and dipropylene glycol mono-n-butyl ether (DPnB), which are commercially available from Dow Chemical Company under the trade name Dowanol DPnP and Dowanol DPnB respectively.

The glycol ether in accordance with the present invention may comprise from about 0.5 w/w % to about 7.5 w/w %, preferably about 2.5 w/w % to about 6.0 w/w %, and more preferably about 4.0 w/w % or 5.0 w/w % of the composition. In one embodiment, the glycol ether is 4.5 w/w % DPnP or DPnB. In another embodiment, the glycol ether is 2.5 w/w % DPnP or DPnB.

To lower the interfacial tension between water and the glycol ether and to disperse the components homogenously in the solution, an effective amount of a surfactant is added to the composition. It is preferred to select a low sodium, non-foaming or low foaming surfactant. It is also preferred to select a biodegradable surfactant.

The term “an effective amount” used herein and in the appended claims refers to a minimum amount of a component which is sufficient to allow the component to perform its desired function.

The surfactant for the present invention may be nonionic, anionic, cationic, zwitterionic and amphoteric. Preferably the surfactant is nonionic. The nonionic surfactant can be selected from, but not limited to, the group consisting of cetyl alcohol, steraryl alcohol, cetostearyl alcohol, oleyl alcohol, octaethylene glycol monododecyl ether, pentaethylene glycol monododecyl ether, decyl glucoside, lauryl glucoside, polyoxyethylene glycol octylphenol ethers, glycerol alkyl esters, glyceryl laurate, cocamide MEA, cocamide DEA, dodecyl dimethylamine oxide, and polyethylene glycol alkylphenyl ether. In one preferred embodiment, nonionic surfactant is polyethylene glycol p-(1,1,3,3-tetramethylbutyl)-phenyl ether, which is available from Dow Chemical Company, under the trade name Triton X-100. Mixtures of these nonionic surfactants may also be used.

Typically, the total amount of the surfactants in accordance with the present invention is in the range of about 0.01 w/w % to about 0.5 w/w %, preferably about 0.05 w/w % to about 0.2 w/w %, and more preferably about 0.1 w/w %.

Water is the remaining component of the composition and is used in an amount to make up the final 100% w/w of the composition. Distilled or purified water, free of minerals, ions, and ion exchange components is preferred to prevent denaturing of active components, such as quaternary ammonium salts. The proportion of water in accordance with the invention is in the range of about 50 w/w % to about 98 w/w % of the composition, and preferably, from about 75 w/w % to about 95 w/w %.

The composition may further comprise one or more optional components such as a fragrance, an anti-forming agent, an antioxidant, a preservative, a builder, a chelating agent, a dye, a brightener, and a pH adjusting agent.

As used herein and in the appended claims, the term “fragrance” is used in its ordinary sense to refer to and include any non-water soluble fragrant substance or mixture of substances including natural, artificial and synthetically produced odoriferous substances. Typically, a fragrance is a mixture of various organic compounds such as alcohols, aldehydes, ethers, and aromatic compounds. The fragrance may have a fresh fruit odor or other pleasing odor.

While the precise composition of the fragrance is of no particular importance to the disinfecting performance, the amount of the fragrance added must be water miscible. Moreover, in order to avoid leaving visible streak or filming on the surfaces after disinfecting, it is preferred to use a minimum amount of the fragrance sufficient to create a pleasing odor. The fragrance in accordance with the present invention may be present in an amount of about 0.4 w/w % to about 0.9 w/w % of the composition.

The disinfecting composition of the present invention may be formulated over a broad range pH range, between about 5.0 to about 11.5, preferably between about 8.5 to about 11.0, and more preferably between about 9.5 to about 10.5. It is discovered that a composition with a higher pH does not improve its disinfecting activity when compared to a composition with a neutral pH.

Without any pH adjusting agent, the compositions in accordance with the present invention have a neutral pH when freshly prepared. During the course of the shelf time, the pH of the compositions may vary from about 5 to about 8. A pH adjusting agent or pH buffer may be added to control or stabilize the pH of the compositions. The pH adjusting agent may be selected from, but not limited to, the group consisting of citric acid, hydrochloric acid, sulfuric acid, sodium hydroxide, mono-, di- and tri-alkanol amines, and buffers. The pH adjusting agent may be present in an amount sufficient to bring the pH of the composition to the desired range.

The following are non-limiting examples of the compositions in accordance with the present invention.

### Examples

TABLE 1
Example Formulations

| | Formulation 1 | Formulation 2 |
|---|---|---|
| | pH = 7 | pH = 7 |
| Ingredient | w/w % | w/w % |
| BTC 2125 ®M | 1.06 | 1.03 |
| Dowanol DPnP | 4.50 | — |
| Dowanol DPnB | — | 2.50 |
| Triton X-100 | 0.10 | 0.10 |
| Fragrance | <0.90 | 0.30 |
| Water | 93.44 | 96.07 |

The Methods of Preparation:

The methods of preparation comprise the steps of formulating, loading, and optionally packaging.

The formulating step involves mixing each component of the liquid composition in a suitable vessel or container until a homogenous suspension or solution is formed. As known to practitioners skilled in this art, the art of mixing may include stirring or other agitating means. It may also include heating the mixture to facilitate the mixing.

In one embodiment, the formulating comprises the steps of mixing a surfactant at a range of about 0.01 w/w % to about 0.5 w/w %, preferably about 0.05 w/w % to about 0.2 w/w %, and more preferably about 0.1 w/w % with water; mixing a glycol ether at a range of from about 0.5 w/w % to about 7.5 w/w %, preferably about 2.5 w/w % to about 6.0 w/w %, and more preferably about 4.0 w/w % or 5.0 w/w % with the water and surfactant; and mixing a quaternary ammonium salt at a range of about 0.2 w/w %) to about 2.0 w/w %, preferably about 0.2 w/w % to about 0.8 w/w %, and more preferably about 0.2 w/w %) to about 0.5 w/w % with the water/surfactant/glycol ether mixture.

In accordance with the present invention, a preferred quaternary ammonium salt of the aforementioned methods for formulation is a mixture n-alkyl (C₁₂-C₁₈) dimethyl benzyl ammonium chloride and n-alkyl (C₁₂-C₁₄) dimethyl ethylbenzyl ammonium chloride; a preferred glycol ether is dipropylene glycol mono-n-butyl ether or dipropylene glycol mono-n-propyl ether; and a preferred nonionic surfactant is polyethylene glycol p-(1,1,3,3-tetramethylbutyl)phenyl ether.

In accordance with the present invention, the quaternary ammonium salt used in the aforementioned methods is preferably at a range of about 0.9 w/w % to about 1.1 w/w %; the glycol ether is preferably at a range of about 4.5 w/w %; and the surfactant is preferably at a range of about 0.1 w/w %.

While there is no particular order in mixing the components, it is preferred to add a surfactant or co-solvent into water first to assist the dissolution of the other components. While several components may be added to water simultaneously or pre-mixed prior to adding to water, it is preferred that only one component is added each time to water and mixed until a clear aqueous solution or homogeneous suspension is obtained.

The step of formulating may also comprise mixing an optional component in water, wherein the optional component is selected from the group consisting of an anti-forming agent, an antioxidant, a preservative, a builder, a chelating agent, a dye, a brightener, and combinations thereof.

Lastly, the step of formulating may further comprise adjusting the pH of the resulting liquid with a pH adjusting agent. The pH adjusting agent may be selected from, but not limited to, the group consisting of citric acid, hydrochloric acid, sulfuric acid, sodium hydroxide, mono-, di- and tri-alkanol amines, and buffers.

The resulting liquid from the formulating is then loaded on a nonwoven water-insoluble substrate. The substrate can be made from the materials including, but not limited to, viscose, rayon, polyester, wood pulp, polypropylene, polyethylene, nylon, and cotton. The basis weight of the substrate for the wipes is from about 10 grams per square meter (gsm) to about 200 gsm, preferably from about 20 gsm to about 100 gsm.

The methods of loading include, but not limited to, spraying, dipping, impregnation, saturating, and brush coating of the disinfecting liquid onto the nonwoven substrate. The loading time and manner may vary with respect to each loading method, as long as the loading level is controlled in the range from about 1.5 xow to about 10 xow, preferably from about 2.5 xow to about 7.5 xow, and more preferably from about 3 xow to about 6 xow.

Optionally, the methods of preparation may further comprise a packaging step. In one embodiment, the pre-impregnated wipes are packaged as a continuous strip of material which has perforations between each wipe and which may be arranged in a stack or wound into a roll for dispensing. In another embodiment, the pre-impregnated wipes are folded into c-folded, z-folded, or quarter-folded configurations and the like, and then stacked in a tub format and placed in the interior of a container or dispenser. Preferably, the container or dispenser is a sealed container. The container is desirably airtight and/or with a resealable opening to prevent evaporation of any of the components of the disinfectant composition. More preferably, each wipe is individually wrapped a sealed foil envelope or a sealed plastic envelope. Various suitable dispensers, containers, and systems for delivering wipes are described in U.S. Pat. No. 5,785,179 to Buczwinski, et al.; U.S. Pat. No. 5,964,351 to Zander; U.S. Pat. No. 6,030,331 to Zander; U.S. Pat. No. 6,158,614 to Haines, et al.; U.S. Pat. No. 6,269,969 to Huang, et al.; U.S. Pat. No. 6,269,970 to Huang, et al.; and U.S. Pat. No. 6,273,359 to Newman, et al., which are incorporated herein in their entirety by reference thereto for all purposes.

The Methods of Disinfecting a Surface:

The methods for disinfecting a surface in accordance with the present invention comprise the step of applying an effective amount of the above described composition onto the surface. In preferred embodiments, the composition is applied with a disposable wipe. However, other applicators may be also used, including sponges, mops and similar products. For example, the pre-impregnated wipes can be attached to a mop head with a handle for added flexibility and convenience.

The basis weight of the wipe is from about 10 grams per square meter (gsm) to about 200 gsm, preferably from about 20 gsm to about 100 gsm. For a light duty disinfecting job, the disinfecting process typically requires only wiping soiled area and lower basis weight wipes are usually employed for the job. For heavy duty disinfecting job, however, the cleaning process may require scrubbing, wiping, rinsing, and combinations thereof, and accordingly industrial wipes, those with higher basis weight and/or an additional scrub layer, are preferred.

Unused wipes should be resealed to prevent evaporation of any of the components of the disinfectant composition. Preferably, each wipe is provided in a sealed foil envelope or a sealed plastic envelope. However, other packaging may be used, such as a plastic box with a resealable opening.

The present invention may be used to disinfect surfaces such as are typically found in residential homes, nursing homes, hospitals, and public institutions, e.g., counter top, table top, sinks, bath tubs, tiles, walls, floors, glass, plastic, household appliances, and the like by wiping a soiled or infected surface with a saturated wipe product.

When the composition uses biodegradable surfactants and glycol ethers and a low level of quaternary ammonium salts, no rinsing is required to form a shiny disinfected surface. Therefore, the processes for disinfecting a surface may further comprise the step of allowing water to evaporate to form a layer of dried components coated on the surface for providing sustained disinfecting efficacy. However, the processes may optionally comprise the step of wiping away the residues or rinsing the surface after a short contact time between the composition and the surface. The contact time may be as little as three minutes.

It should be noted the present invention is not limited to the above descriptions as a person of skill in the art knows that the microbiocidal activity of a disinfecting composition may be manipulated by altering the concentration of its components, temperature, and contact time with a surface.

Efficacy of the Invention

Antibacterial wipes and compositions according to the invention are useful in the cleaning and/or disinfecting of surfaces, especially hard surfaces. The antimicrobial activity includes effects in sanitizing, disinfecting, and/or virocidal reduction of microorganisms, such as, for example, bacteria, viruses, fungi, and the like. Antimicrobial efficacy can be tested in accordance with the AOAC Germicidal Spray Products Test (Method No. 961.02), modified in accordance with the test procedure specified in the American Society for Testing and Materials (ASTM) International's Standard Practice for Evaluation of Pre-saturated or Impregnated Towelettes for Hard Surface Disinfection (E2362-09), or the EPA's Standard Operation Procedure for Disinfecting Towelette Test against Staphyloccus aureus, Pseudomonas aeruginosa, and Salmonella enterica (SOP #MB-09-04, Revised Feb. 26, 2010).

The present invention has surprisingly improved efficacy against both gram positive microorganisms such as Staphylococcus auresus and gram negative microorganisms such as Salmonella choleraesui, as well as Pseudomonas aeruginosa. It is believed that a synergistic effect occurs with the specific combination of the quaternary ammonium salts, the glycol ether and the nonionic surfactant such as Triton X-100 in accordance with the present invention. As a result, the compositions with a lower level of each of the quaternary ammonium salts, the glycol ether, and Triton X-100 could achieve much more enhanced disinfecting activities than the accumulative disinfecting effects of the separate components. For example, one embodiment of the invention, Formula 1, which comprises 1.06 w/w % of BTC 2125®M, 4.5 w/w % Downanol DPnB, 0.1 w/w % of Triton X-100, <0.9 w/w % a fragrance, and water, demonstrates antibacterial effects after only three minutes contact time between the composition and the infected surface. Without wishing to be bound by theory, it is believed that the specific combination of the nonionic surfactant and the glycol ether works to activate the quaternary ammonium salts which allows the quaternary ammonium salts, even at a low concentration, to act more quickly and effectively by attaching to and breaking down an outer cell membrane of the selected microorganisms. In contrast, a quaternary ammonium disinfecting composition for hard surfaces disclosed in U.S. Pat. No. 5,444,094 requires a medium to high level of glycol ether, from about 8 w/w % to 80 w/w %.

It is also believed that the particular combination of the glycol ether and water forms a hydrophilic layer which promotes a uniform distribution of the quaternary ammonium salt on a surface. Upon evaporation of water, the surface is coated with a layer of complex containing the evenly distributed quaternary ammonium salt, glycol ether and nonionic surfactant which may provide sustained germicidal activity for the surface. Advantageously, when biodegradable glycol ethers and nonionic surfactants are used, no removal of the residues is required and the compositions are cost effective and environmental friendly.

The disinfecting properties of the present invention were studied as described below. The efficacy of wipes impregnated with Example Formula I was tested based on the methodology of the AOAC Germicidal Spray Products Test as modified by the (ASTM) International's Standard Practice for Evaluation of Pre-saturated or Impregnated Towelettes for Hard Surface Disinfection (E2362-09). The organism studied was Pseudomonas aeruginosa, which was obtained from the American Type Culture Collection. The P. aeruginosa was transferred to Trypticase Soy Agar and incubated at 37° C. for 24 hours to form a mature culture. The mature culture was diluted to form a suspension which was transferred onto sterile surfaces of multiple 6″×6″glass carriers and allowed to dry. The carriers contained >1.0×10⁵ CFU/ft² area. One wipe in accordance with the invention was used to wipe four 6″×6″ square glass carriers for a total of 1 ft² area of glass. The wiping was repeated twice more, with 4 carriers each time. The carrier was treated with the wipe with two passes. A control set of carriers was left unwiped. Each carrier was allowed to set for a 3 minute contact time, then transferred to a sterile bag containing 800 mL of AOAC neutralizer broth. An aliquot from the wipe was expressed into a sterile jar containing 100 ml of AOAC neutralizer broth. The bag containing the carriers was sealed and sonicated for 5 minutes in an ultrasonic bath. The surface suspension and the aliquot suspension were assayed using membrane filtration. The membrane filters were transferred to the surface of Tryptone Glucose Extract Agar plates and were incubated for 48-72 hours at 35° C.-37° C. The Agar plates were then examined for growth. Control sets of Agar plates was also recorded.

Table 2 demonstrates the results of the test.

TABLE 2
Test Results of Example Formulation

| | | P. aeruginosa | P. aeruginosa |
|---|---|---|---|
| Medium | Volume Filtered | CFU/filter | CFU/1 ft² |
| Surface | 800 ml | 0 | 0 |
| suspension | | | |
| Wipe Aliquot | 100 ml | 0 | |
| Suspension | | | |
| Surface | 800 ml | 0 | 0 |
| suspension | | | |
| Wipe Aliquot | 100 ml | 0 | |
| Suspension | | | |
| Surface | 800 ml | 0 | 0 |
| suspension | | | |
| Wipe Aliquot | 100 ml | 0 | |
| Suspension | | | |
| Control Carrier | | | 2.9 × 10⁵ |

As can be seen, the testing of the example formulation was successful, with no occurrences of the P. aeruginosa in the 3 minute exposure test.

In summary, Formulation 1 (pH=7.0) is an effective disinfecting composition that demonstrates an effective disinfecting performance. Three minutes is sufficient contact time between the composition and the infected surfaces to achieve the aforementioned disinfecting efficacy. No improvement in the disinfecting efficacy is observed by extending the contact time to ten minutes.

While described in terms of the presently preferred embodiments, it is to be understood that the present disclosure is to be interpreted as by way of illustration, and not by way of limitation, and that various modifications and alterations apparent to one skilled in the art may be made without departing from the scope and spirit of the present invention.

What is claimed is:

1. An antimicrobial wipe for use on hard surfaces comprising:
(a) an absorbent substrate; and
(b) a composition comprising:
(i) about 0.2 w/w % to about 2.0 w/w % of C₁₂-C₁₈ alkyl dimethyl benzyl ammonium chloride, C₁₂-C₁₄ alkyl dimethyl ethylbenzyl ammonium chloride, and mixtures thereof;
(ii) about 0.5 w/w % to about 7.5 w/w % of dipropylene glycol mono-n-butyl ether, dipropylene glycol mono-n-propyl ether, and mixtures thereof;
(iii) about 0.01 w/w % to about 0.5 w/w % of an ethoxylated nonionic surfactant; and
(iv) the balance being water;
wherein the substrate is impregnated with the composition at a loading level from about 1.5 xow to about 10 xow.

2. The antimicrobial wipe of claim 1, wherein the substrate comprises viscose, rayon, polyester, wood pulp, polypropylene, polyethylene, nylon, or cotton.

3. The antimicrobial wipe of claim 2, wherein the substrate has a basis weight from about 10 grams per square meter to about 200 grams per square meter.

4. The antimicrobial wipe of claim 3, wherein the substrate has a basis weight from about 20 grams per square meter to about 100 grams per square meter.

5. The antimicrobial wipe of claim 3, wherein the substrate is impregnated with the composition at a loading level of about 2.5 xow to about 7.5 xow.

6. The antimicrobial wipe of claim 5, wherein the substrate is impregnated with the composition at a l loading level of about 3 xow to about 6 xow.

7. The antimicrobial wipe of claim 1, wherein the composition comprises about 0.2 w/w % to about 0.8 w/w % of C₁₂-C₁₈ alkyl dimethyl benzyl ammonium chloride, C₁₂-C₁₄ alkyl dimethyl ethylbenzyl ammonium chloride, and mixtures thereof.

8. The antimicrobial wipe of claim 7, wherein the composition comprises about 0.2 w/w % to about 0.5 w/w % of C₁₂-C₁₈ alkyl dimethyl benzyl ammonium chloride, C₁₂-C₁₄ alkyl dimethyl ethylbenzyl ammonium chloride, and mixtures thereof.

9. The antimicrobial wipe of claim 1, wherein the composition comprises about 2.5 w/w % to about 6.0 w/w % of dipropylene glycol mono-n-butyl ether, dipropylene glycol mono-n-propyl ether, and mixtures thereof.

10. The antimicrobial wipe of claim 9, wherein the composition comprises about 4.0 w/w % to about 5.0 w/w % of dipropylene glycol mono-n-butyl ether, dipropylene glycol mono-n-propyl ether, and mixtures thereof.

11. The antimicrobial wipe of claim 10, wherein the composition comprises about 4.5 w/w % dipropylene glycol mono-n-propyl ether.

12. The antimicrobial wipe of claim 1, wherein the composition comprises about 0.05 w/w % to about 0.2 w/w % of an ethoxylated nonionic surfactant.

13. The antimicrobial wipe of claim 12, wherein the ethoxylated nonionic surfactant is polyethylene glycol p-(1,1,3,3-tetramethylbutyl)phenyl ether.

14. The antimicrobial wipe of claim 13, wherein the composition comprises about 0.1 w/w % of polyethylene glycol p-(1,1,3,3-tetramethylbutyl)phenyl ether.

15. The antimicrobial wipe of claim 1, wherein the pH of the composition is between about 5.0 to about 11.5.

16. The antimicrobial wipe of claim 15, wherein the pH of the composition is about 7.

17. An antimicrobial wipe for use on hard surfaces comprising:
(a) an absorbent nonwoven substrate; and
(b) a liquid composition comprising:
(i) a quaternary ammonium salt at a range of about 0.2 w/w % to about 2.0 w/w %;
(ii) a glycol ether at a range of about 0.5 w/w % to about 7.5 w/w %;
(iii) a surfactant at a range of about 0.01 w/w % to about 0.5 w/w %; and
(iv) the balance being water;
wherein the substrate is pre-impregnated with the composition at a loading level from about 1.5 xow to about 10 xow.

18. The antimicrobial wipe of claim 17, wherein the quaternary ammonium salt is selected from the group consisting of alkyl dimethyl benzyl ammonium chloride, alkyl dimethyl ethylbenzyl ammonium chloride, dialkyl dimethyl ammonium chloride, dialkylmethyl amine, and mixtures thereof.

19. The antimicrobial wipe of claim 18, wherein the quaternary ammonium salt is about 0.2 w/w % to about 0.8 w/w % of the composition.

20. The antimicrobial wipe of claim 19, wherein the quaternary ammonium salt is about 0.2 w/w % to about 0.5 w/w % of the composition.

21. The antimicrobial wipe of claim 19, wherein the quaternary ammonium salt is selected from the group consisting of C₁₂-C₁₈ alkyl dimethyl benzyl ammonium chloride, C₁₂-C₁₄ alkyl dimethyl ethylbenzyl ammonium chloride, and mixtures thereof.

22. The antimicrobial wipe of claim 18, wherein the glycol ether is selected from the group consisting of dipropylene glycol mono-n-propyl ether and dipropylene glycol mono-n-butyl ether.

23. The antimicrobial wipe of claim 22, wherein the glycol ether is about 2.5 w/w % to about 6.0 w/w % of the composition.

24. The antimicrobial wipe of claim 23, wherein the glycol ether is dipropylene glycol mono-n-propyl ether.

25. The antimicrobial wipe of claim 24, wherein the glycol ether is about 4.0 w/w % to about 5.0 w/w % of the composition.

26. The antimicrobial wipe of claim 21, wherein the surfactant is selected from the group consisting of cetyl alcohol, steraryl alcohol, cetostearyl alcohol, oleyl alcohol, octaethylene glycol monododecyl ether, pentaethylene glycol monododecyl ether, decyl glucoside, lauryl glucoside, polyoxyethylene glycol octylphenol ethers, glycerol alkyl esters, glyceryl laurate, cocamide MEA, cocamide DEA, dodecyl dimethylamine oxide, polyethylene glycol alkylphenyl ether, and mixtures thereof.

27. The antimicrobial wipe of claim 26, wherein the surfactant is about 0.05 w/w % to about 0.2 w/w % of the composition.

28. The antimicrobial wipe of claim 27, wherein the surfactant is polyethylene glycol p-(1,1,3,3-tetramethylbutyl)phenyl ether.

29. The antimicrobial wipe of claim 28, wherein the surfactant is about 0.1 w/w of the composition.

30. A method of preparation of a disinfecting wipe comprising the steps of:
(a) mixing about 0.01 w/w % to about 0.5 w/w % of an ethoxylated nonionic surfactant with water;
(b) mixing about 0.5 w/w % to about 7.5 w/w % of dipropylene glycol mono-n-butyl ether, dipropylene glycol mono-n-propyl ether, and mixtures thereof with the mixture of step (a); and
(c) mixing about 0.2 w/w % to about 2.0 w/w % of C₁₂-C₁₈ alkyl dimethyl benzyl ammonium chloride, C₁₂-C₁₄ alkyl dimethyl ethylbenzyl ammonium chloride, and mixtures thereof with the mixture of step (b); and
(d) loading the mixture of step (c) to a non-woven substrate until a loading level is in the range from about 1.5 xow to about 10 xow.

31. The method of preparation of claim 30, wherein the loading is performed by spraying, dipping, impregnating, saturating or brush coating.

32. The method of preparation of claim 31 further comprising: packaging the loaded substrate in a sealed container.

33. A method of disinfecting a surface comprising the step of:
applying an effective amount of a disinfecting composition onto a surface by wiping the surface with a pre-impregnated wipe containing the disinfecting composition, said disinfecting composition comprising:
about 0.2 w/w % to about 2.0 w/w % of C₁₂-C₁₈ alkyl dimethyl benzyl ammonium chloride, C₁₂-C₁₄ alkyl dimethyl ethylbenzyl ammonium chloride, and mixtures thereof;
about 0.5 w/w % to about 7.5 w/w % of dipropylene glycol mono-n-butyl ether, dipropylene glycol mono-n-propyl ether, and mixtures thereof;
about 0.01 w/w % to about 0.5 w/w % of an ethoxylated nonionic surfactant; and
water.

34. The method of claim 33, wherein the surface comprises a counter top, table top, sinks, bath tubs, tiles, walls, floors, glass, plastic, or household appliance.

35. The method of claim 33, wherein the surface comprises a hospital area or hospital equipment.

36. A disinfecting composition, comprising:
0.2 w/w % to about 2.0 w/w % of C₁₂-C₁₈ alkyl dimethyl benzyl ammonium chloride, C₁₂-C₁₄ alkyl dimethyl ethylbenzyl ammonium chloride, and mixtures thereof;
0.5 w/w % to about 7.5 w/w % of dipropylene glycol mono-n-butyl ether, dipropylene glycol mono-n-propyl ether, and mixtures thereof;
0.01 w/w % to about 0.5 w/w % of an ethoxylated nonionic surfactant; and
water.
